(19) United States
(12) Patent Application Publication
(10) Pub. No.: US 2010/0321809 A1
(43) Pub. Date: Dec. 23, 2010

(54) DEVICE FOR PROTECTION AND SPACE SAVING CAMERA LENS HOOD

(76) Inventor: Timothy Paul Fung, Hong Kong (CN)

Correspondence Address: AKERMAN SENTERFITT, P.O. BOX 3188, WEST PALM BEACH, FL, 33402-3188, US

(21) Appl. No.: 12/820,206

(22) Filed: Jun. 22, 2010

(30) Foreign Application Priority Data
Jun. 23, 2009 (HK) HK1128186

(51) Int. Cl. G02B 7/00

(52) U.S. Cl. 359/896

(57) ABSTRACT

A device for the protection of camera lens and the fixation of cameras, the device is a screw up bolt, its special feature lies in the screw-up-bolt being a round stub, the inner dimension of the bolt is to connect with the outer bottom of the camera with a matching thread or bolt flute. It could screw up with the bolt stub with inner screw thread, and to match up in accordance with the sizes of camera lens in varied screw threads of different designs by various manufacturers. The device could screw up with the bolt at both ends to connect with camera lens, therefore, it could connect two camera lens at the same time.

### FIELD OF THE INVENTION

This invention involves a device for photograph taking and photographic accessories, in the instance of a camera lens for TV imaging taking; specifically it is a protective device to protect camera from scratches and to save storage spacing in camera bag and a stationary device.

### BACKGROUND OF THE INVENTION

For taking photograph of better quality, types of lens becomes more and more precision, and the demand for better lens quantity also increases, photographic taking lovers are bound in possession of two or more than two lens for taking stunning scenery, and characteristic imaging for memory and appreciation.

No matter it is a digital camera or a traditional camera, lens plays a crucial factor in the quality of good imaging. Therefore, it is usual for camera to have lens protective devices for protection against scratches, dusting, oily stains and finger-print marks. Camera lens are a highly precision and expensive accessory which called for tender care, it is the eye of the camera sharing the same important role as a human eye, and careful protection is just the right thing to do.

But the conventional types of lens storage bags selling on the market, its storage space for putting in lens is limited, maximum for two long range lenses or one long and one short lens each, and they have to be stored independently in almost the whole bagging space, not to mention other cleansing and other accessories for the lens. Therefore, photo taking lovers would have to make restrictive choice in carrying along lens, and may possibly missing out more multiple modes of imaging taking but not having the full fun of photograph taking, or alternatively to bear the trouble of taking along two lens storage bags. To cope with the above mentioned shortcomings in lens storage, this invention is to make improvements pin-pointing the above mentioned defects.

### SUMMARY OF THE INVENTION

The invention of camera protective cap is not only to protect against scratches and oily stains, and dusty pollutants, the innovation is to connect two lenses through an interlocking bolts and nuts in reducing space in the storage bag. Making use of this invention, the space in the storage bag could be greatly increased and to make available more room for photo taking lovers carrying along more different lens for taking more good pictures.

The invention of this innovative device involves a round pole shape locking nuts and bolts made of plastic, the said locking nuts and bolts with inner screw grove or the locking slot mouth matches with the outside screw grove of both nuts and bolts at the base, and both sides of the locking nuts and bolts may lock two lenses at the same time.

The invention of interlocking nuts and bolts may vary and match with the diameter and sizes of lenses and the designs of specific manufacturers, whereas the cost of this invention is low which saves lots of money of photo taking lovers.

### BRIEF DESCRIPTION OF THE DRAWINGS

FIG. 1 is the shape of this invention.

FIG. 2 illustrates the invention while in use.

FIG. 3 illustrates the invention and the shape when in use with the camera lens.

FIG. 4 illustrates different shapes of the invention.

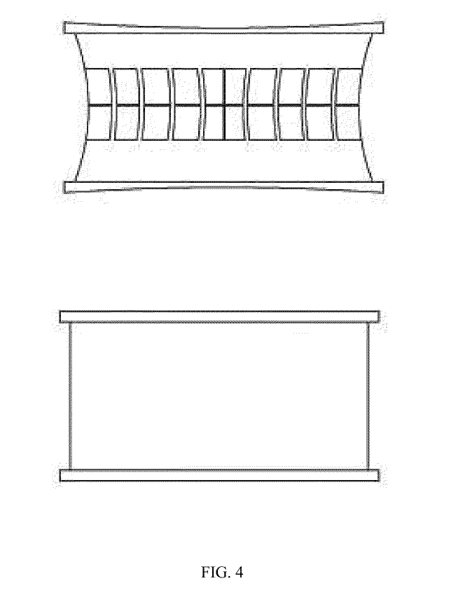

### DETAILED DESCRIPTION OF THE INVENTION

Further description of this invention uses diagrams and operation modes.

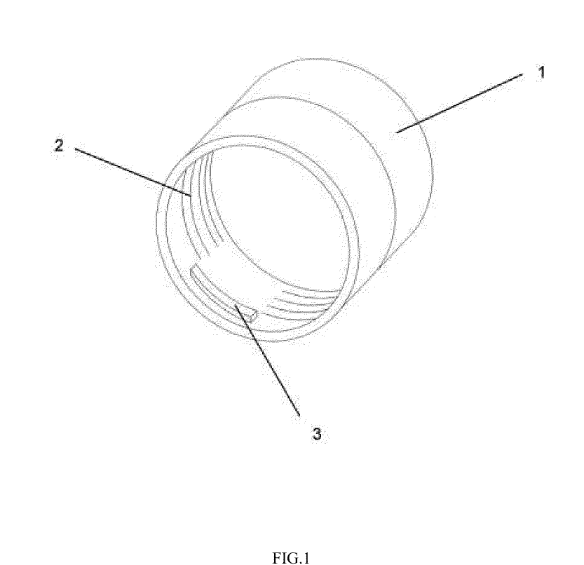

As shown in FIG. 1, this invention of camera protective device is a interlocking bolts and nuts (1), the above-mentioned interlocking bolts and nuts as in (1) round pole shape locking the bolts (1) the inner diameter of camera lens (4) at the base of the screw grove (5) is of the same diameter as that of the outer connecting shaft; the above mentioned locking bolts and nuts are engraved with groves (2) or slot-in mouth (3) interlocking the inner groves (2) of the bolts (1) of the camera connecting the base (4) of outer grove with matching bolts and nuts (5).

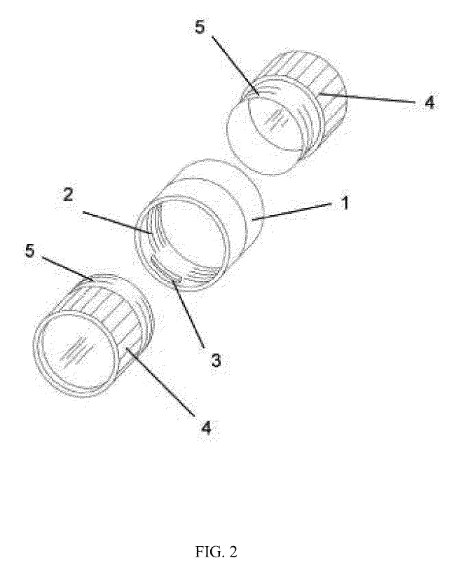

As shown in FIG. 2 of this invention which illustrated the operation of the protective hood while in use, the interlocking bolts (1) when screw in the camera lens (4) at the base of inner grove (2) connecting the camera with the outer grove, then with the interlocked bolts (1) screw in facing the camera (4) getting close to the lens, in this way, the camera lens (4) could be securely locked with the bolts (1), not easy to get lose.

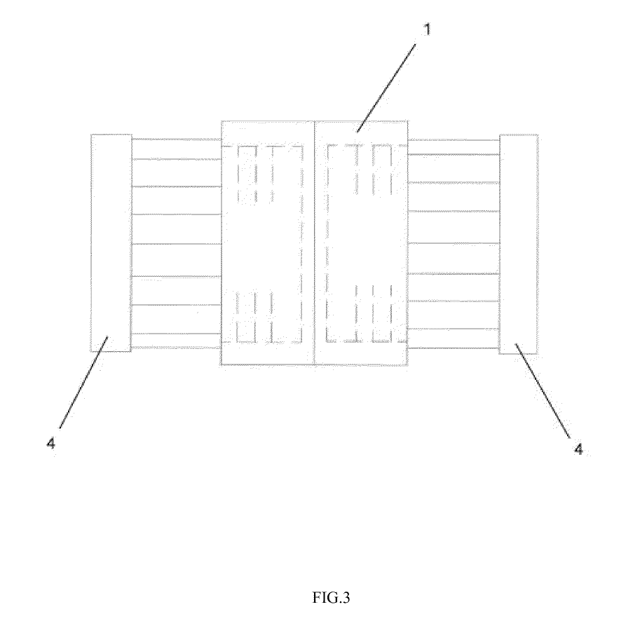

As show in FIG. 3 using the same way of connecting, to screw in another camera lens (4) securely to the other end of the bolts (1), it can connect two lenses at the same time minimizing the encroachment of space of the camera storage bag.

What is claimed is:

1. One type of camera lens, the device is a interlocking nuts and bolts, its characteristic lies in the said locking nuts and bolts which is a round pole shape shaft, matching same with the inner locking shaft and the outer locking groves at the base of the lenses, the said locking nuts and bolts of both inner groves and outer groves are engraved with matching nuts and bolts at the base of the lens and a slot-in mouth.

2. In accordance with the specific interlocking bolts and nuts as mentioned in claim 1, its characteristic lies in the invention of these interlocking nuts and bolts may vary and match with the diameter and sizes of lenses and the designs of specific manufacturers.

3. In accordance with the specific interlocking bolts and nuts as mentioned in claim 1, its characteristic lies in the interlocking bolts and nuts may connect with the lenses at both ends and to connect two lenses at the same time.
